(19) United States
(12) Patent Application Publication
(10) Pub. No.: US 2010/0022672 A1
(43) Pub. Date: Jan. 28, 2010

(54) ION EXCHANGE POLYMER

(75) Inventor: Ken YOSHIMURA, Tsukuba-shi (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Tokyo (JP)

(21) Appl. No.: 12/507,105

(22) Filed: Jul. 22, 2009

(30) Foreign Application Priority Data
Jul. 24, 2008 (JP) 2008-190647

(51) Int. Cl. C08J 5/20

(52) U.S. Cl. 521/27

(57) ABSTRACT

The present invention provides an ion exchange polymer. The ion exchange polymer has two or more heterocyclic groups, each of which contains a nitrogen atom and is a mono-valent cation.

### BACKGROUND OF THE INVENTION

1. Field of the Invention

The present invention relates to a novel ion exchange polymer.

2. Description of the Related Art

Ion exchange polymers are roughly classified into cation exchange polymers and anion exchange polymers depending on the kind of an ion exchange group contained in the polymer, and widely utilized for water treatments (for example, demineralizing treatment), vapor (gas) separation, separation and purification of foods and medicinal products, waste water treatment, wet refining, cell barrier membrane material, and the like. Of them, for cell barrier membranes (barrier membrane for cell), particularly, for barrier membranes for solid polymer type fuel batteries (hereinafter, described as “fuel cell”), cation exchange polymers have been investigated mainly until now.

Recently, as the barrier membrane for fuel cell, use of an anion exchange polymer is sometimes investigated. As such an anion exchange polymer, those used for water treatment and waste water treatment have been conventionally investigated, and specifically, there are suggestions on anion exchange polymers obtained by introducing a quaternary ammonium group into an olefin polymer such as a styrene-divinylbenzene copolymer, and anion exchange polymers obtained by introducing a quaternary alkylammonium group into a polysulfone polymer (Angew. Chem. Int. Ed., 46, 8024-8027 2007, and Fuel Cell, 5(2), 187-200, 2005).

### BRIEF SUMMARY OF THE INVENTION

It has been pointed out, however, that when anion exchange polymers including a quaternary ammonium group hitherto investigated are used as a barrier membrane for cell, an anion exchange polymer constituting the barrier tends to degrade due to heat generation occurring by use of the cell.

The present invention has an object of solving such a problem, and provides an anion exchange polymer manifesting sufficient durability also against heat generation occurring by use of the cell, namely, sufficient heat resistance while having practical ion conductivity as a barrier membrane for a cell, particularly for a polymer electrolyte fuel cell (polymer electrolyte membrane).

The present inventors have intensively studied to attain the above-described object, and resultantly completed the present invention.

That is, the present invention provides <1> to <9>.

<1> An ion exchange polymer having two or more heterocyclic groups, each of which contains a nitrogen atom and is a mono-valent cation.

<2> The polymer according to <1>, wherein at least one of the heterocyclic groups is selected from the group consisting of the members represented by the following formulae (A-1) to (A-11):

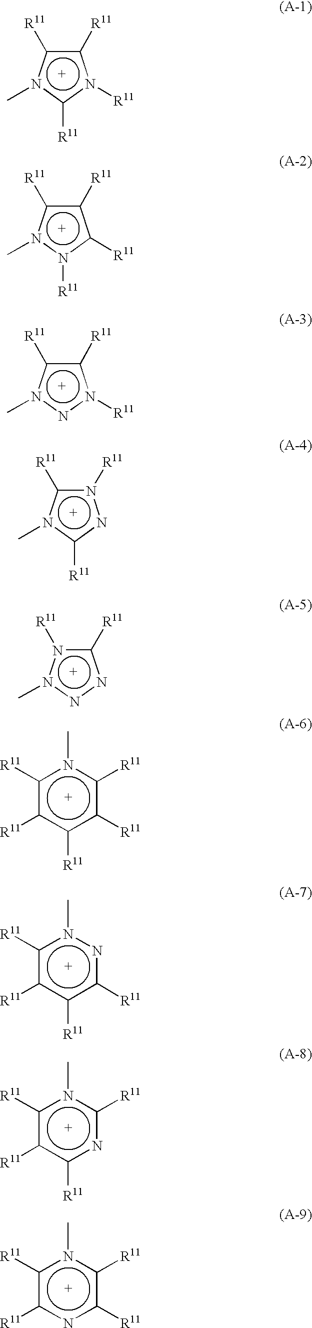

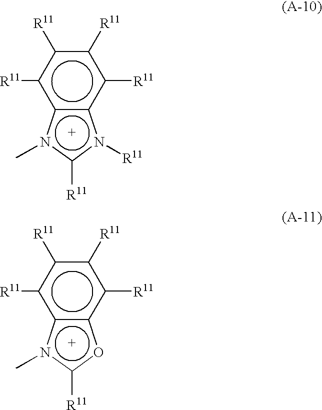

wherein, in the formulae, R¹¹ in each occurrence independently is selected from among an alkyl group having 1 to 6 carbon atoms, alkenyl group having 2 to 6 carbon atoms, alkoxy group having 1 to 6 carbon atoms, aralkyl group having 7 to 12 carbon atoms, phenyl group, halogen atom and hydrogen atom, wherein the sign “+” put in a ring in each formula indicates delocalization of positive charges in the ring.

<3> A polymer electrolyte comprising the polymer as described in <1> or <2>.

<4> A polymer electrolyte membrane comprising the polymer electrolyte as described in <3>

<5> A catalyst layer for fuel cell comprising the polymer electrolyte as described in <3> and a catalyst component.

<6> A membrane-electrode assembly comprising the polymer electrolyte membrane as described in <4> and/or the catalyst layer for fuel cell as described in <5>.

<7> A polymer electrolyte fuel cell comprising the membrane-electrode assembly as described in <6>.

<8> A method for producing an ion exchange polymer comprising the steps of
(a) haloalkylating an aromatic polymer containing an aromatic ring in the main chain of the polymer to obtain Polymer A, and
(b) reacting Polymer A with a heterocyclic compound to substitute a halogen atom in a haloalkyl group in Polymer A with the heterocyclic group of the heterocyclic compound to obtain an ion exchange polymer.

<9> The method according to <8>, wherein the step (b) comprises the sub-steps of preparing a solution containing Polymer A and the heterocyclic compound, applying the solution on a supporting substrate, and heating the resultant.

The ion exchange polymer of the present invention is useful as a barrier membrane particularly for a polymer electrolyte fuel cell. According to the ion exchange polymer, a barrier membrane having high heat resistance as well as practical ion conductivity is obtained. Therefore, the ion exchange polymer of the present invention is capable of fully restraining heat deterioration and the like occurring by use of a cell, particularly, of a fuel cell.

### DESCRIPTION OF THE PREFERRED EMBODIMENTS

### Ion Exchange Polymer

The ion exchange polymer of the present invention has two or more heterocyclic groups. Each of the heterocyclic groups contains a nitrogen atom and is a mono-valent cation. The heterocyclic herein referred to means a cyclic compound containing a hetero atom, that is, a heterocyclic compound, and the heterocyclic group means a group obtained by removing one hydrogen atom from a heterocyclic compound, and/or, a state in which a hetero atom in a heterocyclic compound has positive charge (being cation) and is capable of forming a bond directly or via other atom or atomic group to the main chain of a polymer.

Preferable examples of the heterocyclic compound include pyrrole, 3-pyrroline, pyrrolidine, pyrazole, 2-pyrazoline, pyrazolidine, imidazole, oxazole, thiazole, 1,2,3-oxadiazole, 1,2,3-triazole, 1,2,4-triazole, 1,3,4-thiadiazole, pyridine, piperidine, morpholine, pyridazine, pyrimidine, pyrazine, piperazine, 1,3,5-triazine, indole, benzimidazole, benzoxazole, benzothiazine, purine, quinoline, isoquinoline, 1,2,3,4-tetrahydroquinoline, 1,2,3,4-tetrahydroisoquinoline, perhydroquinoline, perhydroisoquinoline, isoxazolidine, imidazoline, thiazoline, cinnoline, quinoxaline, carbazole, acridine, phenothiazine, aziridine, azetidine, isooxazole, isothiazole, 1,8-diazabicyclo(5.4.0)undecene-7, 1,5-diazabicyclo(4.3.0)nonene-5, or compounds obtained by connecting a nitrogen atom in these compound with a hydrogen atom or mono-valent organic group to form an ion. The heterocyclic compound can be converted into a heterocyclic group by removing a hydrogen atom, and may optionally have a substituent within a range of no extreme deterioration of anion exchangeability by the heterocyclic group.

The ion exchange polymer preferably includes a heterocyclic group containing an aromatic property. In the heterocyclic group containing an aromatic property, when ionized to get positive charge, the positive charge is delocalized owing to the aromatic property, consequently, the positive charge tends to be stabilized, thus, an ion exchange polymer containing the heterocyclic group containing an aromatic property is more excellent in ion exchangeability.

The heterocyclic group containing a nitrogen atom and an aromatic property is a group obtained by removing one hydrogen atom from an aromatic heterocyclic compound containing a nitrogen atom (nitrogen-containing aromatic heterocyclic compound). Examples of the nitrogen-containing aromatic heterocyclic compound include pyrrole, pyrazole, imidazole, oxazole, thiazole, 1,2,3-oxadiazole, 1,2,3-triazole, 1,2,4-triazole, 1,3,4-thiadiazole, pyridine, pyridazine, pyrimidine, pyrazine, indole, benzimidazole, benzoxazole, benzothiazole, purine, quinoline, isoquinoline, 1,2,3,4-tetrahydroquinoline, 1,2,3,4-tetrahydroisoquinoline, cinnoline, quinoxaline, carbazole, acridine, phenothiazine, isooxazole, isothiazole, or compounds obtained by connecting a nitrogen atom in these compound with a hydrogen atom or mono-valent organic group to form an ion. Also the nitrogen-containing aromatic heterocyclic compound can be converted into a heterocyclic group by removing a hydrogen atom, and may optionally have a substituent within a range of no extreme deterioration of anion exchangeability by the heterocyclic group, and also permissible are aromatic heterocyclic compounds obtained by connecting a substituent to a nitrogen element constituting a ring of the aromatic heterocyclic compound to attain positive charge of the nitrogen element. Further permissible are heterocyclic groups obtained by removing a hydrogen atom from any of resonance structures in a nitrogen-containing aromatic heterocyclic compound. Hereinafter, the heterocyclic group obtained from a nitrogen-containing aromatic heterocyclic compound is referred to as “nitrogen-containing heterocyclic group”.

The ion exchange polymer may have a form in which a heterocyclic group is connected directly to the main chain of the polymer, a form in which a heterocyclic group is connected via a suitable atom or atomic group to the main chain of the polymer, or a combination thereof. In the case of the nitrogen-containing heterocyclic group, a connected form may also be permissible in which a tertiary nitrogen atom constituting a ring of a nitrogen-containing aromatic heterocyclic compound and the polymer main chain connected directly or via a suitable atom or atomic group, to quaternarize the tertiary nitrogen atom, giving a nitrogen atom having positive charge (being cation). The ion exchange polymer has preferably a form in which a heterocyclic group is connected via a suitable atom or atomic group to the main chain of the polymer.

The nitrogen-containing heterocyclic group is represented by the member of the following formulae (A-1) to (A-11).

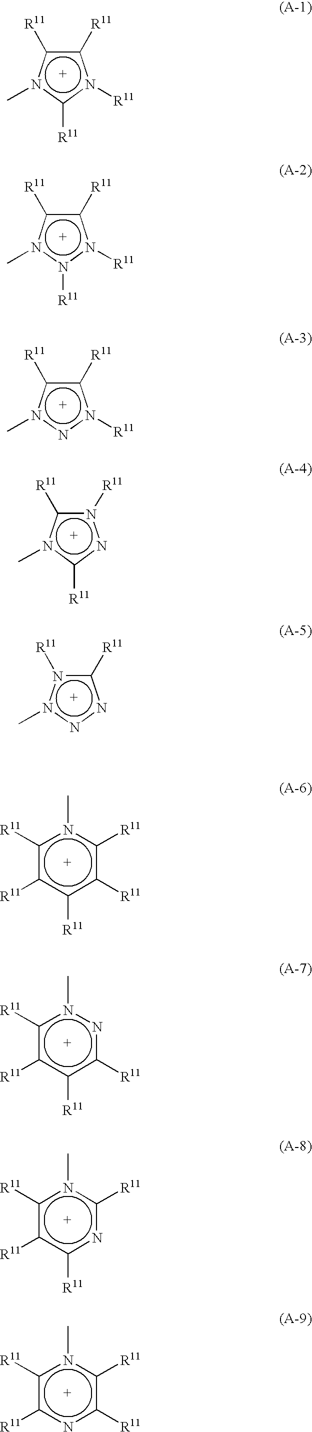

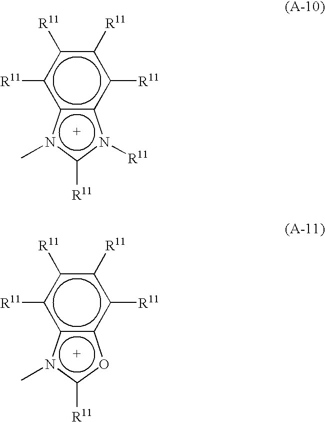

In the formulae, R¹¹ represents the same meanings as described above, and the sign “+” put in an ring in each formula also has the same definition as described above.

R¹¹ is, for example, an alkyl group, alkenyl group, alkoxy group or aralkyl group.

Examples of the alkyl group having 1 to 6 carbon atoms include a methyl, ethyl, propyl, isopropyl, n-butyl, isobutyl, sec-butyl, tert-butyl, pentyl, hexyl, and cyclohexyl. Examples of the alkenyl group having 2 to 6 carbon atoms include a vinyl, and allyl. Examples of the alkoxy group having 1 to 6 carbon atoms include a methoxy, ethoxy, butoxy, hexyloxy, and cyclohexyloxy. Examples of the aralkyl group having 7 to 12 carbon atoms include a benzyl, and phenylethyl.

When R¹¹ is a halogen atom, examples of the halogen atom include a fluorine atom, chlorine atom and bromine atom.

The nitrogen-containing heterocyclic group is represented by more preferably any of the formulae (A-1) to (A-5), and (A-7) to (A-10), further preferably any of the formulae (A-1) to (A-5), still further preferably any of the formulae (A-1) to (A-3), and particularly preferably the formula (A-1).

In the ion exchange polymer, the nitrogen-containing heterocyclic group is ion-bonded to a suitable counter ion (counter anion) to give electrical neutrality. The counter anion is a mono-valent anion such as OH⁻, Cl⁻, Br⁻, and I⁻. When the ion exchange polymer is used as a polymer electrolyte of a barrier membrane for cell, it is preferable that substantially all of counter anions bonded to the nitrogen-containing heterocyclic group in the ion exchange polymer are OH⁻.

The ion exchange polymer is an aromatic polymer containing an aromatic ring in the main chain, in which the aromatic ring is connected mainly by a direct bond, connected via a suitable atom or atomic group, or by a combination thereof. When aromatic rings are connected via an atomic group, it is preferable that the atomic group is no-aliphatic chain.

Examples of the aromatic ring include a mono-cyclic aromatic ring such as a benzene ring, poly-cyclic aromatic ring such as a naphthalene ring, anthracene ring, aromatic heterocyclic ring such as a pyridine ring, and poly-cyclic aromatic heterocyclic ring such as a benzimidazole ring.

Examples of the aromatic polymer include a polyphenylene polymer, polynaphthylene polymer, polyphenylene ether polymer, polyphenylene sulfide polymer, polyether ether ketone polymer, polyether ether sulfone polymer, polysulfone polymer, polyether sulfone polymer, polyether ketone polymer, and polybenzimidazole polymer. Of them, more preferable are polyphenylene ether polymer, polynaphthylene polymer, polyphenylene polymer, polyether sulfone polymer and polyether ether sulfone polymer, particularly preferable are polyether sulfone polymer and polyether ether sulfone polymer.

The aromatic ring constituting the main chain of the ion exchange polymer has an anion exchangeable heterocyclic group as a side chain, and may also has a substituent other than heterocyclic groups. Examples of the substituent include a hydroxyl; alkyl group having 1 to 6 carbon atoms such as a methyl, ethyl, and propyl; alkoxy group having 1 to 6 carbon atoms such as a methoxy, and ethoxy; aralkyl group having 7 to 12 carbon atoms such as a benzyl; aryl group such as a phenyl, and naphthyl; halogen atom, and the like. A plurality of substituents may be present, and in this case, a plurality of substituents may be mutually the same or different.

### Method for Producing an Ion Exchange Polymer

It is preferable that an ion exchange polymer is produced by a method in which a precursor (precursor polymer) containing a reactive group into which a nitrogen-containing heterocyclic group can be introduced is prepared, and then the nitrogen-containing heterocyclic group is introduced by a reaction with the reactive group of the precursor polymer because the operation is simple. It is preferable that the reactive group is include a group having high reactivity into which a heterocyclic group can be introduced easily by a reaction with a nitrogen-containing heterocyclic compound, preferably, a nitrogen-containing aromatic heterocyclic compound. From such a standpoint, preferable examples of the reactive group include a haloalkyl (halogenated alkyl), and it is preferable that an ion exchange polymer is produced using a precursor polymer containing a haloalkyl group (haloalkylated aromatic polymer, hereinafter described as Polymer A).

The haloalkyl group preferably has 1 to 8 carbon atoms, more preferably 1 to 4 carbon atoms. Further, from the standpoint of obtaining an ion exchange polymer having excellent heat resistance, it is preferable to produce an ion exchange polymer using Polymer A containing a haloalkyl group having 1 carbon atom. Preferable examples of the haloalkyl group include a halogenated methyl, 2-halogenated ethyl, 3-halogenated propyl, 4-halogenated butyl, 5-halogenated pentyl, and 6-halogenated hexyl. These haloalkyl groups may also be those in which a part of methylene groups in the alkyl group is substituted by a di-valent group such as an oxy group (—O—), and thioxy group (—S—) providing the reactivity for introducing a nitrogen-containing heterocyclic group is not disturbed extremely. The haloalkyl group may have any substituent in a range not remarkably disturbing the reactivity with a nitrogen-containing heterocyclic compound.

For producing Polymer A, a haloalkyl group can be introduced into an aromatic polymer by substituting a hydrogen atom in an aromatic ring of an aromatic polymer as described above with a halogenated alkyl group (substitution reaction, step a). A chloromethyl group is particularly preferable as the haloalkyl group because the substitution reaction of the haloakyl group for an aromatic polymer is easier. The method for substituting a hydrogen atom in an aromatic ring of an aromatic polymer with a chloromethyl group is, for example, a method comprising the step of reacting an aromatic polymer with an electrophilic reactive chloromethylating agent such as (chloromethyl)methyl ether, 1,4-bis(chloromethoxy)butane, and 1-chloromethoxy-4-chlorobutane. Another method for substituting a hydrogen atom in an aromatic ring of an aromatic polymer with a chloromethyl group is a method in which an electrophilic reactive chloromethylating agent is generated in the reaction system such as a method of using formalin and hydrogen chloride together, method of using p-formaldehyde and hydrogen chloride together, and method of using dimethoxymethane and thionyl chloride together. Examples of a reaction catalyst in introducing a chloromethyl group into an aromatic polymer include tin chloride, and zinc chloride.

In production of Polymer A, the introduction amount of a haloalkyl group within a prescribed range can also be adjusted using a reaction terminating agent. For example, in production of Polymer A into which a chloromethyl group as a suitable haloalkyl group is introduced, a compound containing a methoxy group is added as the reaction terminating agent during the reaction of an aromatic polymer with a chloromethylating agent.

Examples of a compound containing a methoxy group which can be used as the reaction terminating agent include a methoxy alcohol such as 1-methoxyethanol, and 2-methoxyethanol, aromatic compound containing a methoxy group such as anisole, and p-methoxyphenol, and compound containing two methoxy groups such as 1,2-dimethoxyethane.

Ion exchange polymers can be produced by reacting Polymer A, preferably a polymer containing a chloromethyl group among from Polymer A with a nitrogen-containing heterocyclic compound. For producing an ion exchange polymer having one or more of nitrogen-containing heterocyclic groups represented by the above-described formulae (A-1) to (A-11), one or more of nitrogen-containing aromatic heterocyclic compounds represented by the formulae (B-1) to (B-11) may be advantageously used. A tertiary nitrogen atom constituting a ring of the nitrogen-containing aromatic heterocyclic compounds represented by the formulae (B-1) to (B-11) can be substitution-reacted with a halogen atom in a haloalkyl group of Polymer A to provide a quaternary-ionized heterocyclic group.

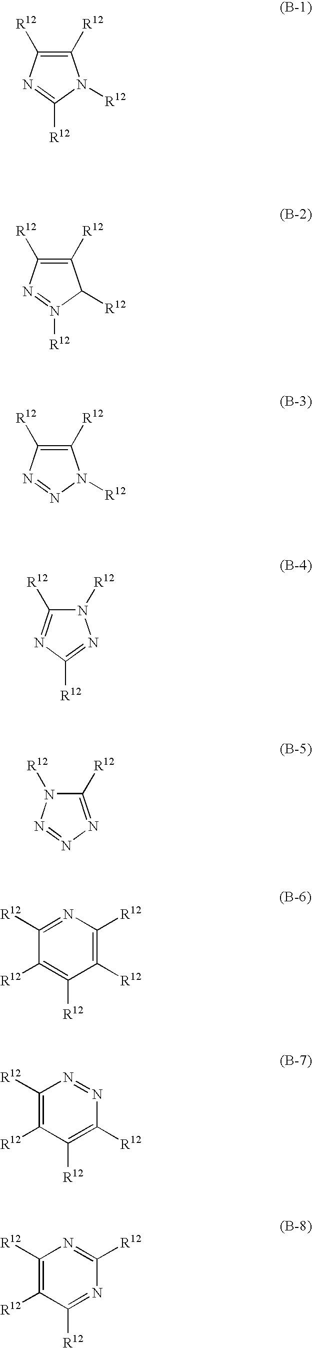

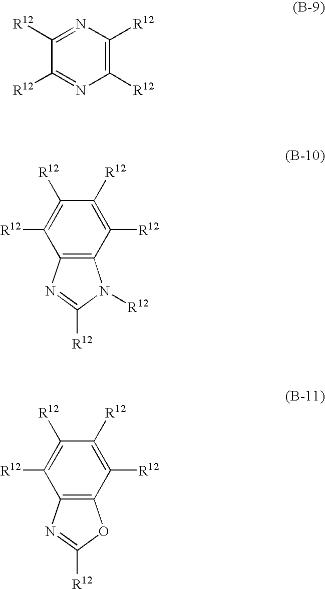

In the formulae, R¹² in each occurrence independently is selected from among an alkyl group having 1 to 6 carbon atoms, alkenyl group having 2 to 6 carbon atoms, alkoxy group having 1 to 6 carbon atoms, aralkyl group having 7 to 12 carbon atoms, phenyl group, halogen atom and hydrogen atom, like R¹¹.

In addition to the step of reacting Polymer A with one or more of nitrogen-containing aromatic heterocyclic compounds represented by the formulae (B-1) to (B-11), a method of making the resultant ion exchange polymer into a membrane together with a method for producing an ion exchange polymer will be illustrated.

For example, these methods are as follows.

(1) Polymer A is dissolved in a solvent, a heterocyclic compound is added to the resultant Polymer A solution, and the solution is flow-cast on a substrate. The solution flow-cast on the substrate is heated, thereby reacting Polymer A and the heterocyclic compound while distilling the solvent off to obtain a membranous ion exchange polymer.

(2) Polymer A is dissolved in a solvent, the resultant Polymer A solution is cast on a substrate. The solvent is distilled off to obtain Polymer A solution, which is molded into Polymer A membrane. A heterocyclic compound is brought into contact with Polymer A membrane thereby reacting Polymer A and the heterocyclic compound to obtain an ion exchange polymer in the form of membrane.

Polymer A is reacted with a heterocyclic compound to obtain an ion exchange polymer. The ion exchange polymer is changed into an ion exchange polymer solution using a suitable solvent. The ion exchange polymer solution is casted by a solution cast method to form a membrane containing the ion exchange polymer.

The conditions of the reaction of Polymer A with the heterocyclic compound are described in detail.

The reaction temperature is usually in the range of −50 to 200° C., preferably 0 to 150° C., particularly preferably 20 to 100° C.

The solvent is a compound can dissolve Polymer A. Preferable examples of the solvent include an aprotic polar solvent such as N,N-dimethylformamide (DMF), N,N-dimethylacetamide (DMAc), N-methyl-2-pyrrolidone (NMP), and dimethyl sulfoxide (DMSO); chlorine-based solvent such as dichloromethane, chloroform, 1,2-dichloroethane, chlorobenzene, and dichlorobenzene; alcohol such as methanol, ethanol, and propanol; and alkylene glycol monoalkyl ether such as ethylene glycol monomethyl ether, ethylene glycol monoethyl ether, propylene glycol monomethyl ether, and propylene glycol monoethyl ether. These solvents may be used singly or in combination with another or more. Of them, DMSO, DMF, DMAc, NMP or, mixture thereof are preferable. Since these preferable solvents are relatively excellent in dissolvability of the ion exchange polymer, these can be suitably used in a method of producing a membrane containing an ion exchange polymer simultaneously with production of an ion exchange polymer as described in the above method (1).

The ion exchange polymer has an ion exchange capacity of preferably 0.5 to 5 meq/g, more preferably 0.8 to 3 meq/g. The ion exchange polymer having prescribed ion exchange capacity can be produced by adjusting the amount of a haloalkyl group to be introduced into Polymer A and the amount of a heterocyclic compound to be reacted with the haloalkyl group.

In the ion exchange polymer, a counter anion to be bonded to a heterocyclic group can be exchanged to a prescribed ion by an ion exchange reaction, depending on its use. When an ion exchange polymer is used as a barrier membrane for cell, particularly as a barrier membrane for fuel cell, it is preferable that the counter ion is OH as described above. When the ion exchange polymer has a halogen ion as the counter anion, the ion exchange polymer can be immersed in an alkali aqueous solution such as a sodium hydroxide aqueous solution, and potassium hydroxide aqueous solution to cause an ion exchange reaction, to give OH⁻ as the counter anion easily.

The ion exchange polymer can be easily fabricated into a membrane by using a solution cast method.

### Polymer Electrolyte Membrane

The ion exchange polymer can be used to form a barrier membrane for fuel cell (polymer electrolyte membrane), through preparing a membrane containing an ion exchange polymer by the above-described method (1) or (2), or through forming a membrane from the ion exchange polymer by a solution cast method. When the membrane containing an ion exchange polymer is used as a barrier membrane for fuel cell, the membrane has a thickness of preferably 0.1 to 300 μm, further preferably 1 to 100 μm, particularly preferably 5 to 75 μm.

For forming a membrane excellent in dimension stability and handling property or a membrane with practical mechanical strength in use as a barrier membrane for fuel cell, the ion exchange polymer can be composited with porous material to obtain a reinforced composite membrane. Preferable examples of the porous material include non-woven fabric containing polyethylene, polypropylene, polytetrafluoroethylene or the like, and a fine porous membrane formed from a membrane containing one of these materials by a draw expansion method. As the method of compositing with a porous substrate, a wet lamination is adopted in which a porous material is immersed into a solution containing an ion exchange polymer.

When the ion exchange polymer is used as a barrier membrane for fuel cell (polymer electrolyte membrane), the polymer electrolyte membrane may contain an additive in a range in which the polymer electrolyte membrane shows practical ion conductivity to improve various physical properties. Examples of the additive include a plasticizer, stabilizer, and releasing agent. When the additive is used, the additive may be co-dissolved in an ion exchange polymer solution to be used in a solution cast method. According to a mixed co-cast method, the ion exchange polymer can be composite-alloyed with one or more of other polymers.

The ion exchange polymer is not limited to the above-described membrane forms, and may also be molded into bag, hollow thread, hollow tube and the like

It is possible that an ion exchange polymer molded in the form of membrane, bag, hollow thread or hollow tube is irradiated with electron beam or radiation to cross-link the ion exchange polymer, thereby further improving mechanical strength thereof. In this case, it is preferable to control the irradiation quantity of electron beam and radiation in a range not deteriorating the practical ion conductivity of the ion exchange polymer.

As described above, a polymer electrolyte membrane containing an ion exchange polymer can be used suitably, particularly, as a barrier membrane for fuel cell. The polymer electrolyte membrane can be used in other applications. In the applications the polymer electrolyte membrane is used as a separation membrane such as ultrafiltration membrane, reverse permeation membrane, and gas separation membrane.

### Fuel Cell

A fuel cell comprising the ion exchange polymer of the present invention, particularly, a fuel cell comprising a membrane containing the ion exchange polymer will be illustrated.

A membrane-electrode assembly as a basic unit of a fuel cell has a pair of catalyst layers placed facing each other (catalyst layer for fuel cell) and a polymer electrolyte membrane so placed as to be sandwiched by these catalyst layers. A catalyst layer contain a catalyst component. The catalyst layer is usually formed from a catalyst ink which is a liquid composition containing a catalyst component. The catalyst layer is preferably formed by spraying or applying the catalyst ink on both faces of a polymer electrolyte membrane.

Examples of the catalyst component include periodic table VIII to X (VIII) group elements such as platinum group elements (Ru, Rh, Pd, Os, Ir, Pt), and iron group elements (Fe, Co, Ni), periodic table XII (IB) group elements such as Cu, Ag, Au. These may be used singly or in combination with another or more

The catalyst ink usually contains a polymer electrolyte for the achievement of ion conductivity in the catalyst layer. The ion exchange polymer is suitable used as the polymer electrolyte of the catalyst ink.

A material, which can act as a gas diffusion layer, such as carbon paper, can be disposed on catalyst layers on both faces of the membrane-electrode assembly to give a fuel cell.

The fuel cell includes various types of polymer electrolyte fuel cells using a gas fuel such as hydrogen and reformed hydrogen, or liquid fuel such as methanol, ethanol, and hydrazine.

### EXAMPLES

The present invention will be illustrated with reference to the following examples in detail. The scope of the present invention it not limited to these examples.

Ion exchange capacity, ion conductivity and thermal decomposition temperature of a functional group were determined by the following methods.

### Ion Exchange Capacity

An ion exchange polymer was used to form a membrane, the resultant membrane was immersed in an alkali aqueous solution and washed with a large amount of water, thereby ion-exchanging a counter anion of an ion exchange group in the ion exchange polymer by OH⁻. The membrane after ion exchange was thoroughly dried, and about 100 mg of dried weight was weighed precisely. The weighed membrane was immersed in 5 mL of 0.1 N hydrochloric acid, then, 50 mL of ion exchange water was added and allowed to stand for 2 hours. Thereafter, a 0.1 N sodium hydroxide aqueous solution was added gradually to the solution containing this immersed membrane to perform titration, obtaining a neutralization point. Ion exchange capacity was determined from the measured dry weight and the titration amount of a 0.1 N sodium hydroxide aqueous solution necessary for neutralization point.

### Ion Conductivity

Ion conductivity was measured using an alternate current impedance.

### Thermal Decomposition Temperature of a Functional Group (TG-MS)

A sample was heated from room temperature up to 400° C. at a rate of 5° C./min under nitrogen flow, using TG-DTA6300 manufactured by Seiko Instruments Inc. A gas discharged during the heating process was analyzed by ThermoStar (mass spectrometer)manufactured by PFEIFFER VACUUM, and the temperature at the maximum strength of molecular weight 59 (derived from trimethylamine) was measured as the thermal decomposition temperature in Comparative Example 1 and the temperature at the maximum strength of molecular weight 82 (derived from 1-methylimidazole) was measured as the thermal decomposition temperature in Example 1.

### Reference Example 1

### Production of Precursor Polymer

Into a 500 ml flask equipped with a thermometer, dropping funnel and stirrer was charged 200 ml of chloroform and 4.00 g of polysulfone (manufactured by Aldrich) and these were dissolved. To this solution was added at room temperature 4.14 g of dimethoxymethane and 6.45 g of thionyl chloride. Further, 5.43 ml of 1M tin tetrachloride solution (solvent: dichloromethane) was added, and reacted at 60° C. for 8 hours. The reaction liquid was poured into methanol to cause deposition of a polymer which was then recovered by filtration. It was washed with methanol repeatedly, then, dried at 80° C., to obtain 4.90 g of chloromethylated polysulfone. From ¹H-NMR (measurement solvent: heavy chloroform) of the resultant polymer, a peak of a benzyl proton of a chloromethyl group was recognized around 4.6 ppm. The chloromethyl group introduction proportion measured from integration ratio of this was 2.25 per unit repeating unit.

### Example 1

### (Production of Polymer Electrolyte Membrane 1 Containing Ion Exchange Polymer Having a Nitrogen-Containing Heterocyclic Group)

0.50 g of chloromethylated polysulfone obtained in Reference Example 1 was dissolved in 3 ml of N-methyl-2-pyrrolidone to obtain a uniform solution. To this solution was added 218 mg of 1-methylimidazole, and stirred at 60° C. for 1 hour. The reaction liquid was applied on a glass base plate, and the solvent was distilled off on an over of 80° C. A film was peeled from the glass base plate, and immersed in a 2 N potassium hydroxide aqueous solution for 10 hours, further, washed with ion exchange water completely, and further dried, to obtain a polymer electrolyte membrane 1. The ion exchange polymer contained in this polymer electrolyte membrane 1 had a nitrogen-containing heterocyclic group according to the above-described formula (A-1). The ion exchange capacity, ion conductivity and decomposition initiation temperature obtained by TG-MS of the resultant polymer electrolyte membrane 1 are shown in Table 1.

### Comparative Example 1

### (Production of Polymer Electrolyte Membrane 3 Containing Ion Exchange Polymer Containing Quaternary Ammonium Group)

0.50 g of chloromethylated polysulfone obtained in Reference Example 1 was dissolved in 15 ml of N-methylpyrrolidone to obtain a uniform solution. To this solution was added 5 ml of a 30% trimethylamine aqueous solution to give a uniform solution which was then stirred at 60° C. for 1 hour. The reaction liquid was applied on a glass base plate, and the solvent was distilled off on an over of 80° C. A film was peeled from the glass base plate, and immersed in a 2 N potassium hydroxide aqueous solution for 10 hours, further, washed with ion exchange water completely and dried, to obtain a polymer electrolyte membrane 3 (polymer electrolyte membrane containing ion exchange polymer containing quaternary ammonium group). The ion exchange capacity, ion conductivity and decomposition initiation temperature obtained by TG-MS are shown in Table 1.

TABLE 1

| | | | Decomposition |
|---|---|---|---|
| | | Ion exchange | initiation |
| | Ion conductivity | capacity | temperature |
| | S/cm | meq/g | ° C. |
| Example 1 | 1.3 × 10⁻² | 1.9 | 300 |
| Comparative | 1.1 × 10⁻² | 1.3 | 190 |
| Example 1 | | | |

As shown in Table 1, the membrane containing an ion exchange polymer (polymer electrolyte membrane 1) has an anion exchangeable heterocyclic group (heterocyclic group of the formula (A-1)), and had extremely excellent heat resistance while having practically sufficient ion conductivity. The ion exchange polymer of the present invention is particularly useful as an electrolyte for a polymer electrolyte fuel cell.

On the other hand, the ion exchange polymer containing a quaternary ammonium group as a conventional anion exchange polymer was inferior in heat resistance as compared with the ion exchange polymer of the present invention.

### Example 2

### (Production of Polymer Electrolyte Membrane 2 Containing Ion Exchange Polymer Having Nitrogen-Containing Heterocyclic Group)

0.50 g of chloromethylated polysulfone obtained in Reference Example 1 was dissolved in 5 ml of N-methylpyrrolidone to obtain a uniform solution. This solution was applied on a glass base plate, and the solvent was distilled off on an over of 80° C. A film was peeled from the glass base plate, and this film was immersed in a mixed liquid of 5.00 g of 1-methylimidazole and 5 ml of water, and reacted at 60° C. for 3 days. Thereafter, the membrane was immersed in a 2 N potassium hydroxide aqueous solution for 10 hours, further, washed with ion exchange water completely and dried, to obtain a polymer electrolyte membrane 2. The ion exchange capacity and ion conductivity are shown in Table 2.

TABLE 2

| | | Ion exchange |
|---|---|---|
| | Ion conductivity | capacity |
| | S/cm | meq/g |
| Example 2 | 2.2 × 10⁻² | 2.1 |

The polymer electrolyte membrane 2 obtained in Example 2 has the same heterocyclic group as for the ion exchange polymer constituting the polymer electrolyte membrane 1, and shows heat resistance as high as the polymer electrolyte membrane 1.

1. An ion exchange polymer having two or more heterocyclic groups, each of which contains a nitrogen atom and is a mono-valentcation.

2. The polymer according to claim 1, wherein at least one of the heterocyclic groups is selected from the group consisting of the members represented by the following formulae (A-1) to (A-11): 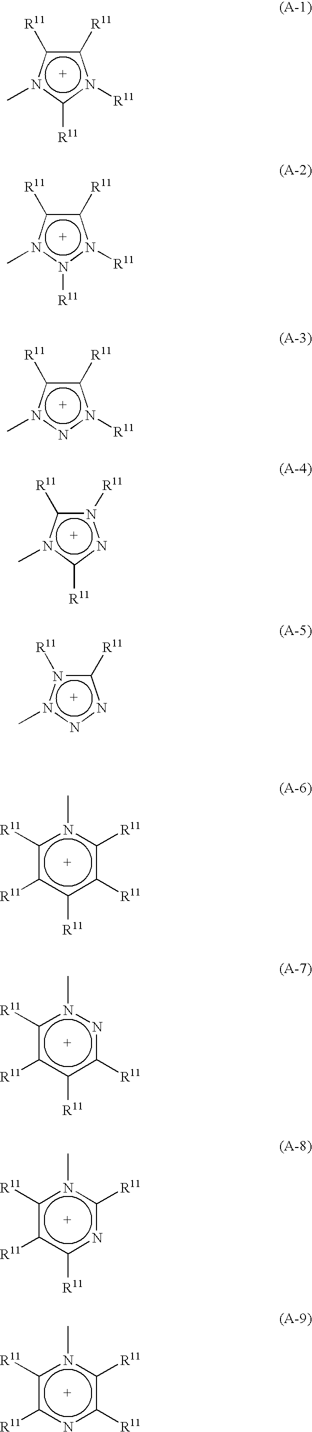 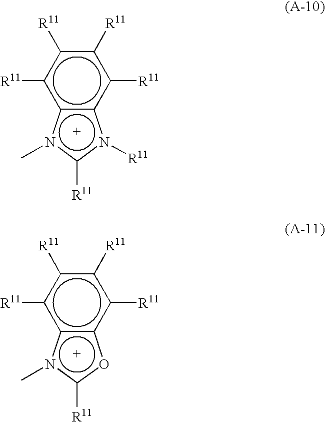
wherein, in the formulae, R¹¹ in each occurrence independently is selected from among an alkyl group having 1 to 6 carbon atoms, alkenyl group having 2 to 6 carbon atoms, alkoxy group having 1 to 6 carbon atoms, aralkyl group having 7 to 12 carbon atoms, phenyl group, halogen atom and hydrogen atom, wherein the sign “+” put in a ring in each formula indicates delocalization of positive charges in the ring.

3. A polymer electrolyte comprising the polymer according to claim 1.

4. A polymer electrolyte membrane comprising the polymer electrolyte according to claim 3.

5. A catalyst layer for a fuel cell comprising the polymer electrolyte according to claim 3.

6. A membrane-electrode assembly comprising the polymer electrolyte membrane according to claim 4.

7. A polymer electrolyte fuel cell comprising the membrane-electrode assembly according to claim 6.

8. A method for producing an ion exchange polymer comprising the steps of
(a) haloalkylating an aromatic polymer containing an aromatic ring in the main chain of the polymer to obtain Polymer A, and
(b) reacting Polymer A with a heterocyclic compound to substitute a halogen atom in a haloalkyl group in Polymer A with the heterocyclic group of the heterocyclic compound to obtain an ion exchange polymer.

9. The method according to claim 8, wherein the step (b) comprises the sub-steps of preparing a solution containing the polymer A and the heterocyclic compound, applying the solution on a supporting substrate, and heating the resultant.

10. A polymer electrolyte comprising the polymer according to claim 2.

11. A membrane-electrode assembly comprising the catalyst layer for a fuel cell according to claim 5.
